(19) United States
(12) Patent Application Publication
(10) Pub. No.: US 2015/0107025 A1
(43) Pub. Date: Apr. 23, 2015

(54) Travel pillow cushion with strap and pouch and seat bracket with support tray for train seats, bus seats and commercial airline seats

(71) Applicant: Joseph Dauphin, Fairfield, CA (US)

(72) Inventor: Joseph Dauphin, Fairfield, CA (US)

(21) Appl. No.: 14/284,663

(22) Filed: May 22, 2014

Related U.S. Application Data
(60) Provisional application No. 61/827,566, filed on May 25, 2013.
(60) Provisional application No. 61/832,995, filed on Jun. 10, 2013.
(60) Provisional application No. 61/835,595, filed on Jun. 16, 2013.

(51) Int. Cl. B60N 2/48; A44B 11/00; F16M 13/02; A47G 9/10

(52) U.S. Cl. CPC B60N 2/4879; A47G 9/10; A47G 9/1027; A44B 11/00; F16M 13/02; A47G 2009/1018; A47G 2009/003
USPC 5/638; 24/68 E; 248/220.21

(57) ABSTRACT

A travel pillow cushion designed with means and devices for anchoring pillow cushion to the head rest of train seats or bus seats using the special adjustable strap with pouch. And for future seat designs you will be able to mount the pillow cushion in front of you using the special bracket with female catch slots and the pillow cushion support tray with male hook hanger end. So that a person can rest during travel in a forward leaning inclined position on a bus seat or train seat.

Cross Reference to related provisional applications not claiming, 61/977,612 date, Apr. 9, 2014 filed by Inventor Joseph Dauphin 61/840,545 date, Jun. 28, 2013 filed by Inventor Joseph Dauphin 61/844,892 date, Jul. 17, 2014 filed by Inventor Joseph Dauphin

Cross reference to related provisional applications claiming, This application claims priority to Provisional Application No. 61/827,566 date, May 25, 2013 filed by Inventor Joseph Dauphin 61/832,995 date, Jun. 10, 2013 filed by Inventor Joseph Dauphin 61/835,595 date, Jun. 16, 2014 filed by Inventor Joseph Dauphin

### BACKGROUND

This Invention relates to Travel pillows for commercial airline seats, Train seats and Bus seats. The design of this pillow cushion is unique because it comes with the proper devices for mounting the pillow cushion to the back of seat in front of your seat using either the special strap with pouch or on future seat designs using the new pillow cushion tray with male hook hanger end and the mounting bracket with female slots, So a person can rest in a forward inclined leaning position with the front of their face resting in the face cavity hole breathing normally.

### PRIOR ART

The following is a tabulation of some prior art that seems relevant.

### U.S. Patents

| Pat. No | Kind Code | Issue date | Patentee |
|---|---|---|---|
| 8,336,142 | B2 | Dec. 25, 2012 | See |
| 6,698,045 | B2 | Mar. 2, 2004 | Anholt |
| 6,684,431 | B2 | Feb. 3, 2004 | Lifegear |
| 6,158,813 | B2 | Dec. 12, 2000 | Karash |
| 8,006,355 | B1 | Aug. 30, 2011 | Anderson |
| 7,543,345 | B2 | Jun. 9, 2009 | Wilson |
| 6,745,418 | B2 | Jun. 8, 2004 | Turner |
| 6,230,350 | N/A | May. 15, 2000 | Goldstein |
| 8,468,628 | N/A | Jun. 25, 2013 | Cheng |
| D656356 | D | Mar. 27, 2012 | Cheng |
| 6,042,185 | N/A | Mar. 28, 2000 | Cowgur |
| 6,647,573 | B2 | Nov. 18, 2003 | Corbin |
| 20130276236 | A1 | Oct. 24, 2013 | Rasmussen |

### Foreign Patent Documents

| | | |
|---|---|---|
| 2061408 | September 1990 | China |
| 102551446 | July 2012 | China |
| 101025713 | March 2011 | KR |

### DESCRIPTION OF PRIOR ART

Goldstein U.S. Pat. No. 6,230,350—and

Cheng patent, U.S. Pat. Nos. 8,468,628—D 656,356—D 655,559

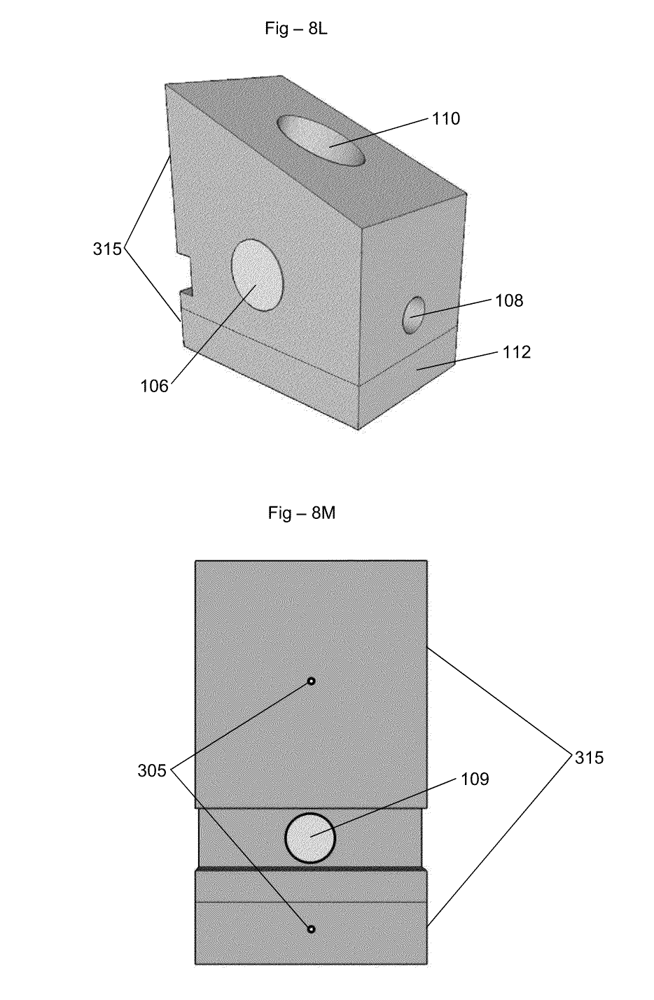

Goldstein and Cheng patents are much the same where they are used as a mattress to lay in a prone position on their stomach with their face in the mattress. The Dictionary states that a pillow is used for laying or resting one's head, and a mattress or bed is used for resting one's body or torso as displayed by Cheng in his drawings in patent 8468628, FIG. 8. And Cheng makes it very clear in his claims that his mattress is used for purpose of inhaling fumes from scent oils. Even if Cheng redesigned his mattress in his design patents into a pillow cushion with a tall semi firm foam base for a person seating in a upright forward leaning inclined position in a seat on an airplane, It would be Lucky to get approval from Transportation Safety Administration, The reason is because the eucalyptus oils and there fumes are highly combustible and flammable and could possibly ignite from a spark from a battery, and just imagine if you had 30 people using a scent dispenser pillow on an airtight airplane and how that might become a toxic environment of different odours that could affect others health and sinus allergy and other breathing concerns.

Cowgur, U.S. Pat. No. 6,042,185—The Cowgur Inflatable pillow is s a pillow that you have to turn your head at about 90 degrees to sleep, it has no face hole or ventilation hole to breath, so imagine sleeping 7 hours with your neck turned at a 90 degree angle, There are many other similar designs on market like the sky rest.

Corbin, U.S. Pat. No. 6,647,573—The Corbin pillow is another example of an inflatable pillow that has a flat surface for you to put a pillow and lay your head at a 90 degree right or left side turn.

Rasmussen, U.S. Ser. No. 13/856,251—Is a pillow cushion with panel walls that have to be taken out of travel bag and assemble on airplane and then the cushion and pillow applied on top. It is basically a product that requires assembly of a multitude of parts and would be very inconvenient on the airplane and I would wonder about its safety due to the fact the bottom is not a solid base and if in the event of hitting a big air pocket on plane and the plane dropped the hard material of panels could cause injury compared to a solid foam cushion that would absorb the impact in case of air turbulence.

And my research has not found any travel pillow that has the means or device for mounting and using a pillow cushion in current bus seats or train seats with head rest like the design in this patent using the special strap with pouch. And for future seat models using the special seat bracket with adjustable female catch slots and pillow cushion tray with male hook hanger end for mounting into bracket with female catch slots whereby supporting the pillow cushion to back of seats.

### SUMMARY

In accordance with one embodiment a travel pillow comprises a semi firm foam base cushion with a hollow cavity connected by ventilation holes and a top face hole, and a softer top layer of foam for comfort. And designed with the proper devices and means to anchor or attach pillow cushion to the back of bus seats and train seats or seat head rest.

### Advantages

Accordingly several advantages of one or more aspects are as follows;

To provide a person with the ability to sleep in a forward inclined leaning position on a commercial airplane with their head in a strait forward inclined leaning position placed inside the top of the pillow cushion which has a hollow cavity connected by ventilation holes allowing the person to rest comfortably without having to rest with their head turned 90 degrees to the side to breath. The cushion is designed to fit under all Airbus and Boeing commercial airline seats for convenience.

To provide a person with the ability to sleep in a forward inclined leaning position on a passenger bus seat or passenger train seat with their head in a strait forward inclined leaning position placed inside the top of the pillow cushion which has a hollow cavity hole connected by ventilation holes and anchored to the seat head rest on the seat in front of you by using the special strap with pouch. And on future seat designs using the special support tray with male hook hanger end and a mounting bracket with female slots for mounting on back of transportation seats in future models of buses and trains.

To provide a person at work or school the ability to take a rest on their lunch break while seating at their desk in a forward inclined leaning position with their head resting comfortably in a strait forward inclined leaning position breathing normally without having to turn their head 90 degrees to breath.

### DRAWINGS

### Figures

### Brief Description of Drawings

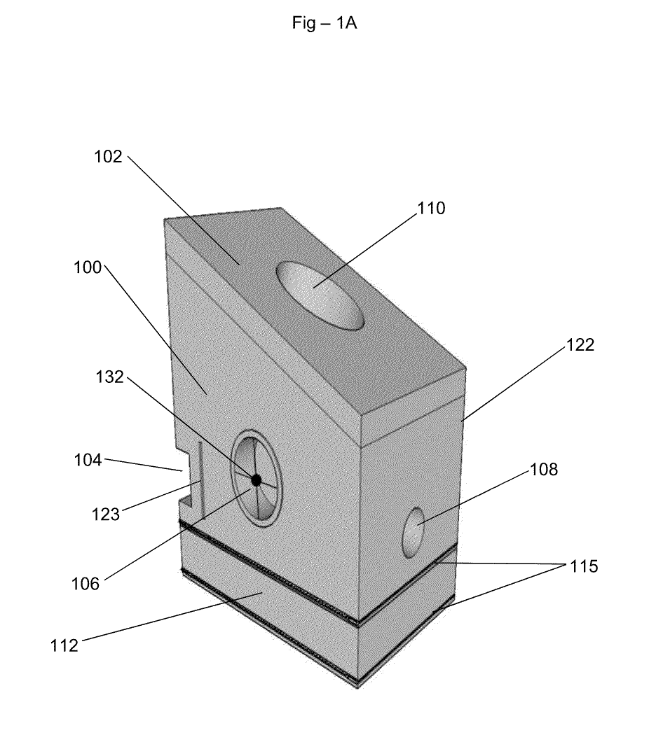

FIG. 1A—Top, left, front view of pillow cushion with extension pad.

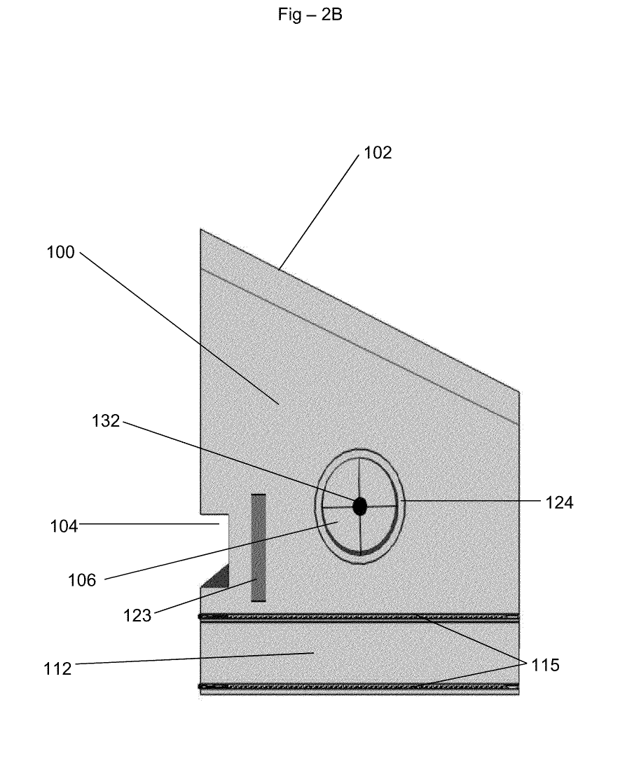

FIG. 2B—Left side view of pillow cushion with extension pad

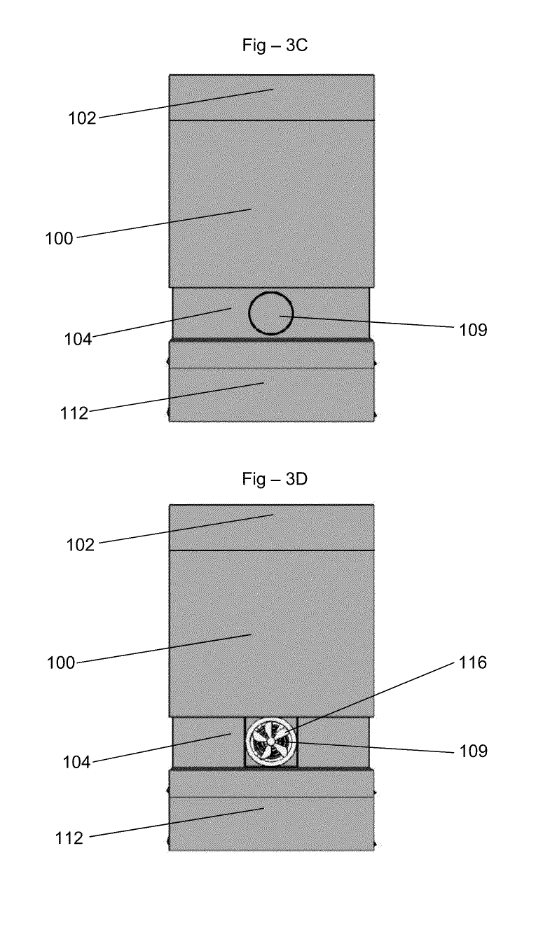

FIG. 3C—Back side view of pillow cushion

FIG. 3D—Back side view of pillow cushion with Mini fan

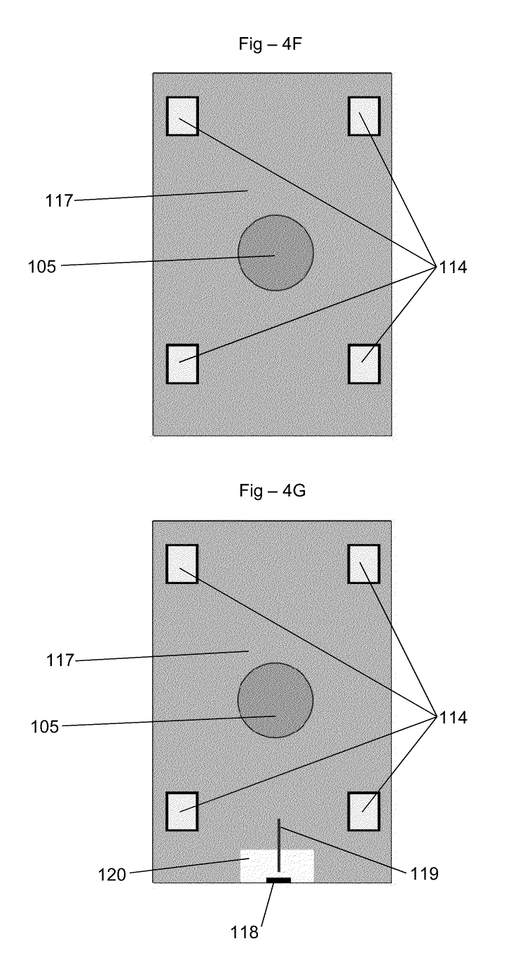

FIG. 4F—Bottom view of pillow cushion without extension pad.

FIG. 4G—Bottom view of pillow cushion without extension pad and with power supply

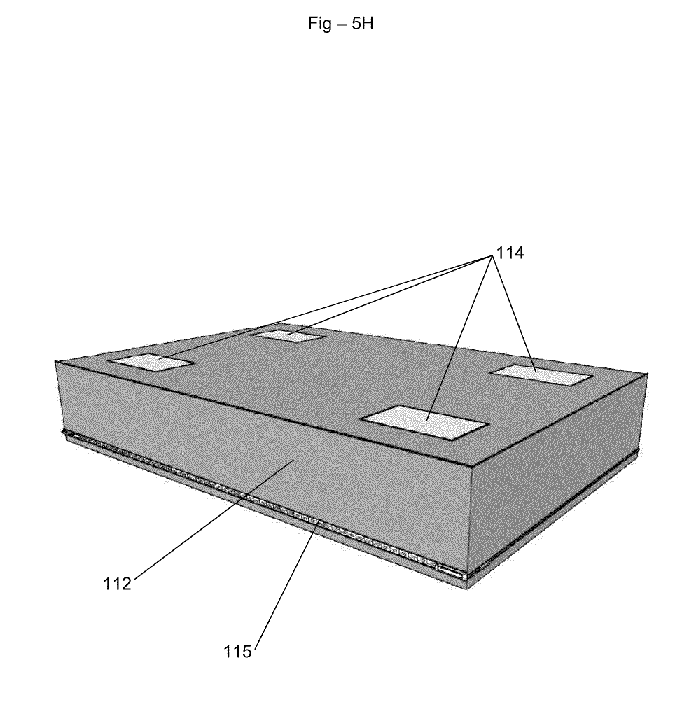

FIG. 5H—Top, left, front view of pillow cushion extension pad

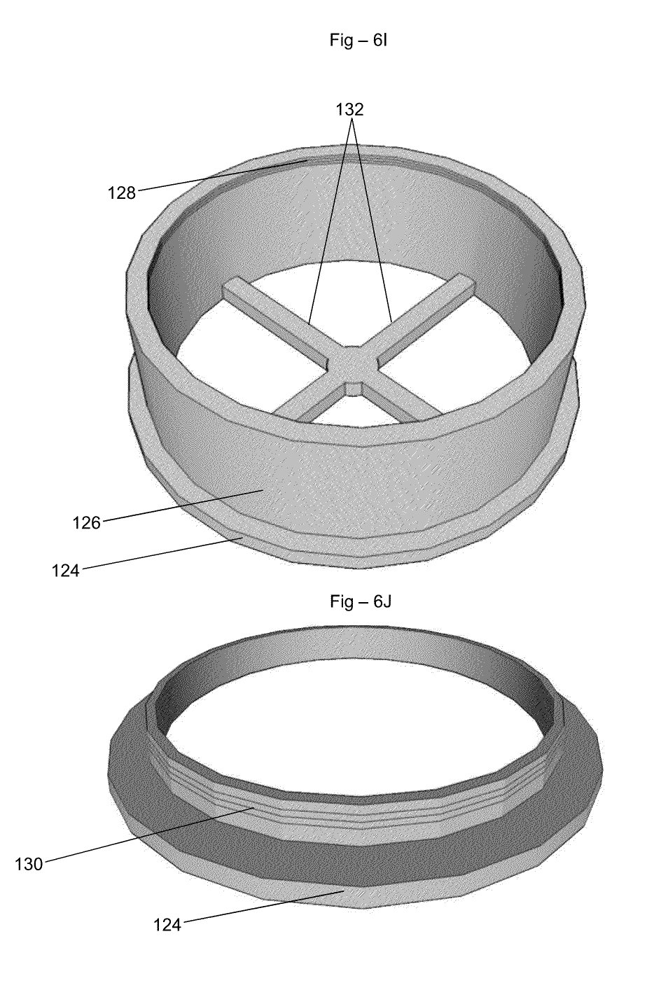

FIG. 6I-Flange cap safety support guard with female threads

FIG. 6J—Flange cap safety support guard with male threads

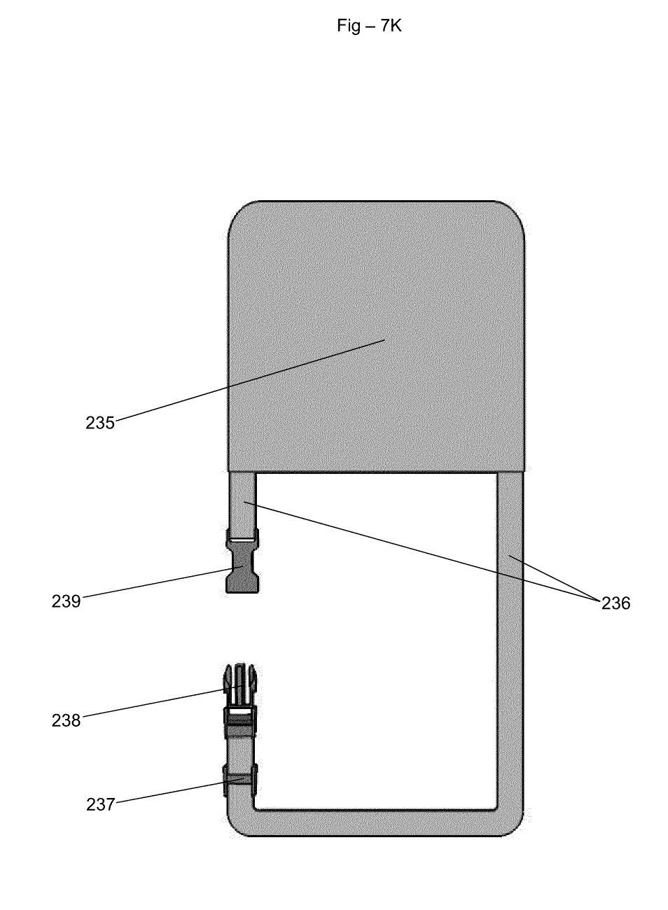

FIG. 7K—Special strap with pouch for mounting pillow cushion to seat head rest.

FIG. 8L—Top, left, front side view of Synthetic rubber inflatable cushion with holes and inflatable extension

FIG. 8M—Back side view of Synthetic rubber inflatable cushion with inflation, deflation air valves and extension pad

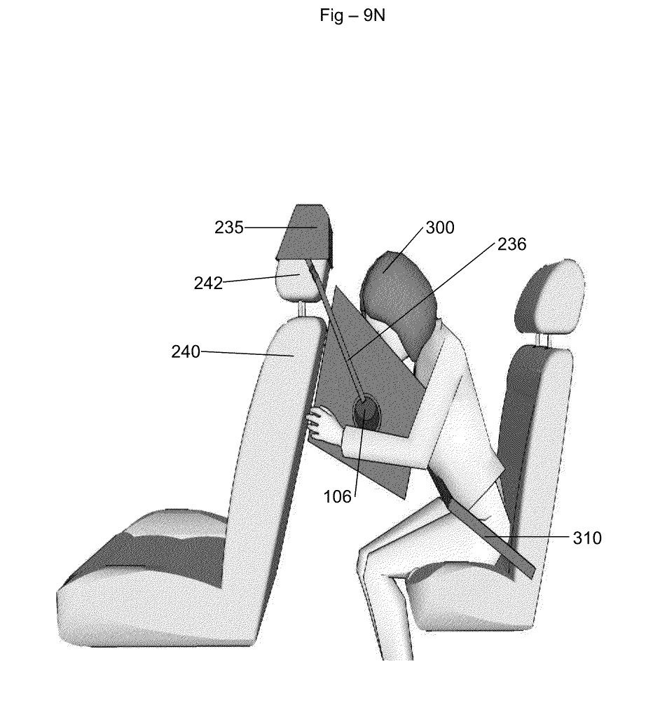

FIG. 9N—Demonstration of a person using the pillow cushion with special strap and pouch in Bus seat or Train seat.

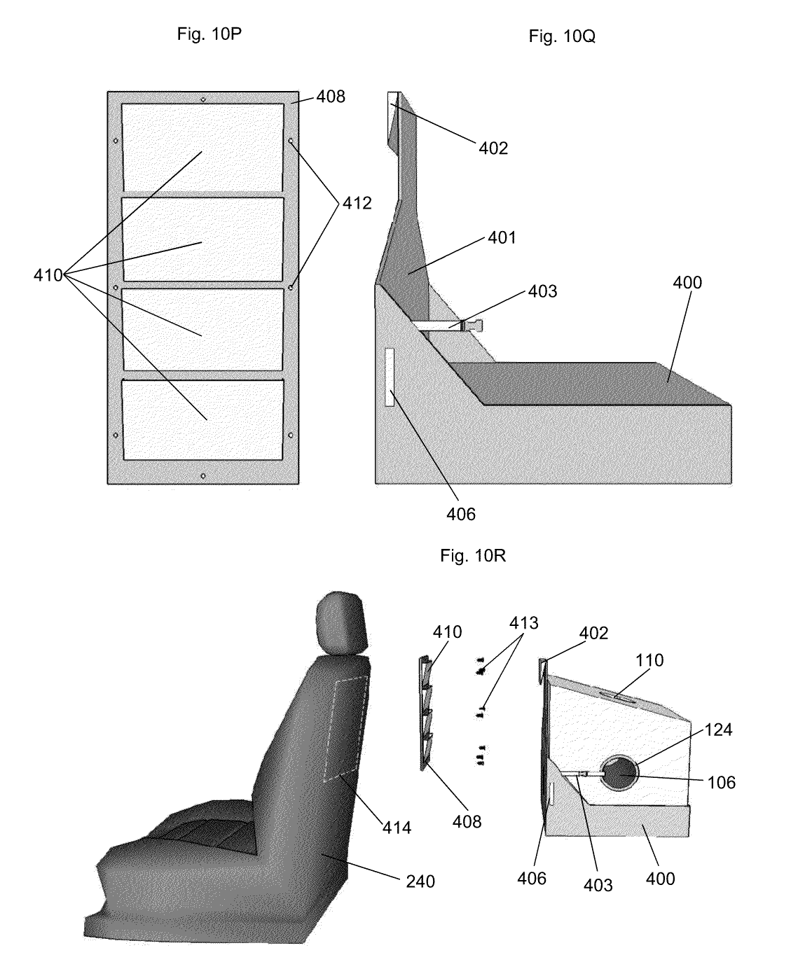

FIG. 10P—Mounting bracket with female catch slots.

FIG. 10Q—Pillow cushion support tray with male hook hanger end.

FIG. 10R—Assembly of tray to bracket and bracket to seat.

### DESCRIPTION OF REFERENCES

Ref. 100, Base foam of pillow cushion.
Ref. 102, Top layer of pillow cushion foam
Ref. 104, Indentation,
Ref. 105, Bottom ventilation hole.
Ref. 106, Left side ventilation hole.
Ref. 107, right side ventilation hole.
Ref. 108, Front side ventilation hole.
Ref. 109, Back side ventilation hole.
Ref. 110, Top face resting hole.
Ref. 112, Extension pad.
Ref. 114, Velcro tabs or matting button snaps.
Ref. 115, Zipper.
Ref. 116, Mini fan.
Ref. 117, Bottom side of pillow cushion.
Ref. 118, Power supply switch.
Ref. 119, Lead wire.
Ref. 120, Power supply box,
Ref. 122, Removable, washable clothe cover.
Ref. 123, Hand grip,
Ref. 124, Outer ring of flange cap safety support guard.
Ref. 126, Inner wall of flange cap safety support guard,
Ref. 128, Female threads of flange cap safety support guard.
Ref. 130, Male ends of flange cap safety support guard.
Ref. 132, Safety guard of flange cap safety support guard,
Ref. 235, Pouch for seat head rest
Ref. 236, Strap for pouch,
Ref. 237, Strap adjuster.
Ref. 238, Male hook end of buckle.
Ref. 239, Female catch end of buckle
Ref. 240, Back of automobile seat.
Ref. 242, Back of seat head rest.
Ref. 300, Human head.
Ref. 305, inflation, deflation valve
Ref. 310, Seat belt
Ref. 315, synthetic rubber or nylon or other PVC inflatable material
Ref. 400, Pillow cushion support tray.
Ref. 401, Back support of tray.
Ref. 402, Male hook hanger end.
Ref. 403, safety strap.
Ref. 406, ventilation hole for indentation.
Ref. 408, Mounting bracket for seat back.
Ref. 410, Female catch slots for receiving male hook hanger end.
Ref. 412, Holes for screws to mount bracket to back of seat.
Ref. 413, screws
Ref. 414, metal support in seat.

### DETAILED DESCRIPTION

### FIG. 1A, 2B, 3C, 4F, 5H, 6I, 6J, 7K, 9N

### First Embodiment

1st embodiment of the pillow cushion is illustrated in 1A (Top, left front view of pillow cushion with extension pad). The cushion has a semi firm base foam 100, and it has a second layer of memory foam 102 or other soft material or foam attached to the top of base foam with a nontoxic adhesive, or heat flame bonding, hot film bonding, powder laminating or sewing. The top of the cushion has a front face hole 110 which goes down inside a hollow cavity in cushion connected by ventilation holes 105, 106, 107, 108, 109, which provide oxygen air to the hollow cavity and up into the face hole 110 for a person to lean in a forward inclined position in a seat or chair and place there head in the face hole 110 and sleep in a forward inclined leaning position in an airline seat using the table tray or bus seat or train seat using the special strap with pouch for seat head rest, or in future designed seats using the special bracket and tray support for pillow cushion for resting without having to turn their head in a 90 degree angle to breath. This will allow the person to avoid any neck and spine complications after a long rest

It comes with a Removable washable clothe cover 122, with zipper 115. It also comes with a hand grip 123 for hands. And it comes with a flange cap safety support guard 132 for two reasons, 1st; it provides the special strap with pouch a hard solid surface to protect the foam from tearing apart from the tension or urging of the strap and weight of a person when it is mounted to a seat head rest due to the weight of person. 2nd, it has a guard on the outside to keep a person from inserting their hands inside of the hollow cavity which could possibly obstruct oxygen air flow to the face hole.

Note; after testing certain prototypes of semi firm density foam it was determined that the base foam was firm enough to support the head of a 280 pound person without a flange cap support guard.

It also comes with an extension pad 112 with a removable, washable clothe cover 122, with zipper 115. And it has a safety feature in the design on the back with an Indentation 104, for the purpose of letting oxygen air access inn and carbon dioxide air access out of the back ventilation hole in case the cushion is pushed up tight to the seat in front of you which would otherwise cause obstruction of air flow if it were not there.

1st embodiment of the pillow cushion is illustrated in FIG. 2B (Left side view of pillow cushion with extension pad) in this view you can see the flange cap safety support guard 132 and the outer ring of Flange cap safety support guard 124 which is there to keep the safety support guard from sliding in and out of the foam cushion. And in this view you can see the indentation 104 better in detail. And also the Hand grip 123 and a better view of the base foam of pillow cushion 100 and the top layer of memory foam of pillow cushion 102. And a view of Left side ventilation hole 106. And extension pads 112, and zippers 115.

1st embodiment of pillow cushion is illustrated in FIG. 3C (Back side view of pillow cushion). In this view you get a better understanding for the need of an indentation 104 for the Back ventilation hole 109 to get proper oxygen air flow into cavity or carbon dioxide air out of cavity in the event the back of cushion is obstructed by the seat in front of you.

1st embodiment of pillow cushion is illustrated in FIG. 4F (Bottom view of pillow cushion without extension pad). In This view you see the Velcro tabs or matting button snaps 114 for attaching the Bottom side of the pillow cushion 117 to the extension pad 112. The Velcro tabs or button snaps 114 are attached to the Removable washable clothe cover 122, and it could have a Bottom ventilation hole 105.

1st embodiment of pillow cushion is illustrated in FIG. 5H (Top, left front view of pillow cushion extension pad). In this view you see the Velcro tabs or button snaps 114 for attaching the Extension pad 112 to the Bottom side of pillow cushion 117. The Velcro tabs or matting button snaps 114 are attached to the removable, washable clothe cover 122 which also has a zipper 115.

Note, Another alternate method of attaching the Base foam of pillow cushion 100 to the Extension pad 112 could be used in a single clothe cover with a double zipper in clothe cover, one zipper for removing extension pad 112 and one zipper for removing Base foam of the pillow cushion 100.

1st embodiment of pillow cushion is illustrated in FIG. 6I (Flange cap safety support guard with female threads). And 6J (Flange cap safety support guard with male threads). The outer wall of the Flange cap safety support guard 126 will be inserted into the Base foam of pillow cushion 100 in left side ventilation hole 106 and right side ventilation hole 107 and the outer ring of flange cap safety support guard 124 will rest flush against the outer side of base foam of pillow cushion 100. The Female threads on inner wall of flange cap safety support guard 128 will be connected to the Male ends of flange cap safety support guard 130 in FIG. 6J, the male end of flange cap safety support guard 130 will be inserted into the Top face resting hole 110 and through the hollow cavity and then screwed into the Female threads on inner wall of flange cap safety support guard 128 until the threads are secure and both outer rings of Flange cap safety support guard 124 are flush and tight against the interior and exterior wall of cavity of Base foam, Sandwiching the base foam of the pillow cushion 100.

Note that the removable, washable clothe cover 122 will be inserted over Base foam of pillow cushion 100 and top layer of pillow cushion 102 before the Flange cap safety support guard 132 will be installed.

Note; The foam can be formed in many ways from mold forming, contour cutting, die cutting, hot wire cutting, computer contour cutting and buffing.

Heretofore again there are two reasons or functions for the flange cap safety support guard in FIGS. 6I and 6J, 1st—to give a hard surface to support the strap for pouch 236 from tearing into the Base foam of the pillow cushion 100 and the Removable, washable clothe cover 122 when the pouch for seat head rest 235 is inserted over back of seat head rest 242 and the Strap for pouch 236 is inserted in through the right side ventilation hole 107 and out the left side ventilation hole 106 and male hook end of buckle 238 is buckled to female catch end of buckle 239 and then the Human head 300 is resting in the Top face resting hole 110 and the weight of the person seating in a forward inclined leaning position is putting pressure on the strap for pouch 236 and the Base foam of the pillow cushion 100. Simply put the Flange cap safety support guard 132 keeps the strap 236 from tearing or urging into the Base foam of the pillow cushion 100.

2nd—The guard on the Flange cap safety support guard in FIG. 6I, 132 is used as a safety device to keep a person from inserting their hands into the Left side ventilation hole 106 and the Right side ventilation hole 107 so the person does not obstruct oxygen air flow to the hollow cavity which connects to the Top face resting hole 110 so the person using the Top face resting hole 110 can have adequate oxygen air for breathing.

Note—Right side ventilation hole 107 is note illustrated in drawings but I included it in reference numbers for explanation purpose only.

### FIG. 1A, 2B, 3D, 4G, 5H, 6I, 6J, 7K, 9N, 90

### Second Embodiment

2nd embodiment of pillow cushion is the same as first embodiment but 2nd embodiment comes with a mini fan 116 in FIG. 3D installed in the back indentation 104 which is connected to lead wire 119 leading to power supply switch 118 which has a power supply box of USB rechargeable power bank or battery tray with batteries. The mini fan is installed backwards so that it will pull carbon dioxide out of the hollow cavity instead of blowing air inward into the hollow cavity. The reason for this is because on an airplane the air quality gets very poor after about 4 hours into a flight and so for those with bronchitis or asthma or other sinus allergy problems it was decided to pull the carbon dioxide out of hollow cavity instead of the fan blowing air into the cavity directly on the face and nose of a person causing allergy sinus problems or other breathing concerns or dry mouth or dry sinus concerns, the fan is installed to pull the carbon dioxide air out of cavity reducing the CFM or cubic feet per minute of air blowing on the person nose because the airflow going into the hollow cavity is distributed through a multitude of ventilation holes.

### FIG. 8L, 8M

### Third Embodiment

3rd embodiment of pillow cushion in FIG. 8I, 8M is basically the same shape but different design because it is made up of an air inflatable bladder made of material selected from a group consisting of rubber, synthetic rubber, PVC or other polyvinyl, nylon, latex or other inflatable material 315. With formed ventilation holes 105, 106, 107 108, 109, 110, it will have a inflation, deflation valve 305 in back and could come with an extension pad 112, And could come with flange cap safety support guard 132. The top of cushion could come with a removable clothe cover and or a removable or permanent cushion on top.

1st, 2nd, and 3rd embodiment of pillow cushion using the (Special strap with pouch for seat head rest for mounting pillow cushion). In FIG. 7K this pouch for seat head rest 235 was designed to utilize the pillow cushion in a train seat 240 or bus seat 240 that has a seat head rest 242 in front of your seat. You insert the Pouch for seat head rest 235 over the top of back seat head rest 242 then you take the long end of Strap for pouch 236 and insert it through the right side ventilation hole 107 and through the hollow cavity of Base foam of the pillow cushion 100 and out the left side ventilation hole 106 and buckle male hook end of buckle 238 to Female catch end of Buckle 239 and then adjust to person proper height using the strap adjuster 237 as demonstrated in FIG. 9N 1st, 2nd, and 3rd embodiment of pillow cushion using the (Mounting bracket with female catch slots) in FIG. 10P and (Pillow cushion support tray with male hook hanger end) in FIG. 10Q.

In future designs of bus seats, train seats and airline seats this new Mounting bracket with Female catch slots FIG. 10P can be implemented into the design in order to provide means of utilizing the pillow cushion using the pillow cushion support tray with male hook hanger end FIG. 10Q.

The new seat design will need a backing support 414 inside the seat frame made of a strong material like metal capable of receiving the screws 413 or rivets or other fastening means so it can receive the mounting bracket assembly 408 with the female slots 410. Screws 413 will be screwed into the holes 412 and will fasten to metal support inside back of seat 414. Then the pillow cushion support tray 400 can be attached to mounting bracket for seat back 408 using the male hook hanger end 402 which will be inserted into one of a multitude of female catch slots 410 and then the pillow cushion base 100 will seat inside the pillow cushion support tray 400 and then you buckle safety strap 403 and lean forward in a inclined position and rest the front of your face in a forward inclined position and breath normally. If cushion is not at a comfortable height for your stature adjust height of pillow cushion by using a multitude of female slots to adjust for your preferred height.

Note; the support tray and bracket can be made of a durable material selected from the group consisting of PVC, plastics, fiberglass, metals, wood, composite fibber material or any combination of materials.

I claim:

1. A pillow cushion comprising of a top face hole connected to a hollow cavity space inside said pillow cushion which is connected by a plurality of side ventilation holes.

2. The pillow cushion of claim 1 wherein said body has a predetermined tall broad rectangular shape and has a slanted angle on top so that the back side of pillow cushion is taller than the front side.

3. The pillow cushion of claim 1 wherein the said body of pillow cushion is made from material selected from the group consisting of foam or a multitude or combination of foam types.

4. The pillow cushion of claim 1 wherein the said body of pillow cushion is an inflatable air bladder and inflation valve made from material selected from the group consisting of polyvinyl, vinyl, rubber, synthetic rubber, latex, or plastic material.

5. The pillow cushion of claim 1 wherein said body of pillow cushion can be surrounded by a removable cover with zipper made of material from the group consisting of metal, vinyl, nylon, cotton cloth, polyester, leather, silk, cashmere.

6. The pillow cushion of claim 5 comprising of a hand grip

7. The pillow cushion of claim 1 comprising a mini fan that is disposed in a ventilation hole installed backwards thereby pulling carbon dioxide air out of cavity hole or installed forward blowing oxygen air into cavity hole.

8. The pillow cushion of claim 1 comprising a rechargeable power bank with universal serial bus charger port and cord.

9. The pillow cushion of claim 1 comprising a flange cap safety support guard with means for supporting strap with pouch and means for guard to keep ventilation holes from being obstructed by human hands

10. The pillow cushion of claim 1 comprising of an indentation in any side of pillow cushion giving it means for allowing air flow in or out of ventilation hole in case of obstruction from other seat.

11. The pillow cushion of claim 1 comprising of an extension pad with means to accommodate a person of tall stature.

12. The pillow cushion in claim 11 wherein the extension pad can be attached to base cushion by means selected from the group consisting of Velcro tabs or mate able button snaps or in a single cover with double zipper.

13. The pillow cushion of claim 1 comprising of a strap with pouch, buckle and adjuster with means for anchoring pillow cushion to seat head rest.

14. The pillow cushion of claim 13 wherein the strap with pouch, buckle and adjuster can be made of material selected from a group consisting of nylon, plastic, clothe, leather, metal, polyvinyl, or textile material or any combination of said materials.

15. The pillow cushion in claim 1 comprising of a pillow cushion support tray with male hook hanger end and a mounting bracket with female catch slots for means of mounting pillow cushion to back of seat.

16. The pillow cushion of claim 15 wherein the said body of the pillow cushion support tray with male hook end and the mounting bracket with female catch slots can be made of durable materials selected from a group consisting of metals, hard plastics, polyvinyl, composite fibber material, fiberglass, wood or any combination of said materials

17. A special strap with pouch, buckle, and strap adjuster with means for anchoring a pillow cushion to the back of a seat head rest.

18. A support tray with male hook end and a mounting bracket with female catch slots with means for mounting a pillow cushion to the back of a seat.
